(19) United States
(12) Patent Application Publication
(10) Pub. No.: US 2007/0255862 A1
(43) Pub. Date: Nov. 1, 2007

(54) Terminal System and User Communication Apparatus Thereof

(76) Inventor: Chiung-Hsien Wu, Taipei (TW)

Correspondence Address: LAW OFFICES OF LAI & ASSOCIATES, P.C., STE 200, 5800 RANCHESTER, HOUSTON, TX, 77036, US

(21) Appl. No.: 11/380,848

(22) Filed: Apr. 28, 2006

(51) Int. Cl. G06F 3/00

(52) U.S. Cl. 710/11

(57) ABSTRACT

This invention discloses a terminal system and a user communication apparatus thereof for an Internet communication. The present terminal system is a low cost structure for the terminal system. The terminal system comprises a communication server for processing main operations, and comprises a plurality of user communication apparatuses. The communication server communicates with and transmits a packet signal to another terminal system through an Internet. The communication server receives a first protocol signal from the user communication apparatus, and transmits a second protocol signal to the user communication apparatus. An operation end transmits a multimedia signal through the user communication apparatus. The operation ends communicate with each other through the communication server and the user communication apparatuses

### FIELD OF THE INVENTION

This invention relates to a terminal system, and more particularly, to a terminal system and a user communication apparatus thereof, which have the advantages of low cost low and expandable application without changing communication protocol.

### DESCRIPTION OF THE RELATED ART

A web phone ignites a new telecommunication revolution. A network user not only transmits data or information through network, but also can transform an analog audio signal to a digital audio signal for telecommunication. The advantages of the web phone comprise low communication fee, globalization and mobility, etc. As the Internet is getting popular, the web phone is accordingly getting to be a main stream consuming products.

Reference is made to FIG. 1 and FIG. 2, wherein FIG. 1 depicts a structure diagram showing a prior internet communication terminal system, and FIG. 2 depicts an operation diagram showing a prior internet communication terminal system. The internet communication terminal system 11 comprises a memory unit 13, a microprocessor 14, a digital signal processor 15, a receiver 16, an amplifier 17 and a button module 12, which are all covered by a telephone casing. When an operation end uses the internet communication terminal system 11, a controlling signal 121 is transmitted to the microprocessor 14 from the button module 12. The amplifier 17 receives a multimedia signal 112 from an outside operation end, and transmits a first audio signal 113 to the digital signal processor 15. The digital signal processor 15 compresses and transforms the first audio signal 113 to a connecting signal 141, and transmits the connecting signal 141 to the microprocessor 14. The microprocessor 14 performs at least an operation of communication protocol, and transmits a packet signal 111 through an internet to another internet communication terminal system 11. Therefore, a sending function for audio signal of the internet communication terminal system 11 is completed.

When the microprocessor 14 receives a packet signal 111 from another internet communication terminal system 11, the microprocessor 14 performs at least an operation of communication protocol, and transmits the connecting signal 141 to the digital signal processor 15. The digital signal processor 15 decodes and un-compresses the connecting signal 141 to a second audio signal 114, and transmits the second audio signal 114 to the receiver 1 6. Then a multimedia signal 112 is transmitted to the operation end. Therefore, a receiving function for audio signal of the internet communication terminal system 11 is completed. The digital signal processor 15 could access a compressed parameter 131 from the memory unit 13, wherein the compressed parameter 131 includes bits for improving the operation speed and reducing the processed signals. The above mentioned sending and receiving functions are performed together for a web phone. As shown in FIG. 2, the internet communication terminal system 11 communicates with another internet communication terminal system 11 through an internet system.

However, since each internet communication terminal system 11 has to perform the functions for processing communication protocol and for processing digital signal, which need expansive IC chips. Therefore, the total cost for web phone is still higher than that for traditional analog telephone. It becomes a difficulty for current web phone industry.

Therefore, the present invention provides an improved terminal system for solving the above mentioned problem.

### SUMMARY OF THE PRESENT INVENTION

It is an aspect of the present invention to provide a terminal system. The terminal system comprises a communication server and at least a user communication apparatus. Each user communication apparatus communicates with another user communication apparatus through the communication server rather than prior internet system. Instead, the function for processing communication protocol and for processing digital signal is performed on the communication server. The cost for web phone of the present invention is accordingly reduced very much.

According to the aforementioned aspect of the present invention, a terminal system for an internet communication is provided. The present terminal system comprises a communication server and at least a user communication apparatus. The terminal system performs an inter communication through a local network, by using a second communication protocol unit embedded in the communication server and a third communication protocol unit embedded in the user communication apparatus. The local network could be a local area network (LAN) or a wireless local area network (WLAN). A first communication protocol unit embedded in the communication server could transmit a packet signal to another terminal system through at least an internet for internet communication. The communication server has a function for processing communication protocol and a function for processing digital signal, which is fulfilled by some expensive devices. Therefore, the cost of the communication server is higher than that of other apparatuses in the present terminal system. That is, the communication server is the most expensive apparatus in the present terminal system. The user communication apparatus comprises a processing module, a button module, and an interface module. The processing module has an operation function of processing a simplified communication protocol. The interface module is for receiving and transmitting signals. The button module is for transmitting a controlling signal. The cost of the user communication apparatus is lower than that of other apparatuses in the present terminal system, such as the communication server. In a same local area network, the communication server communicates with a plurality of user communication apparatuses. In the present structure, the operation end of the user communication apparatuses could use an internet communication together, so that the cost of the terminal system is reduced, and the features of globalization and mobility are remained.

According to the aforementioned aspect of the present invention, a communication server and a user communication apparatus are provided, which make a present terminal system function division efficiently. The cost of the present terminal system could be accordingly reduced. The communication server comprises a first communication protocol unit, a memory unit, a digital signal processing unit and a second communication protocol unit. The first communication protocol unit has at least an operation function of processing an internet communication protocol, real-time transmitting protocol, connecting control protocol, etc. Therefore, the objectives of output transmitting the packet signal, real-time transmitting the packet signal, and unceasing transmitting the packet signal are fulfilled. The digital signal processing unit has at least functions of audio/video signal compressing and processing, which perform compressing, un-compressing, coding, decoding, echo eliminating and comfort signal generating steps on the transmitted packet signal, a first protocol signal and a second protocol signal. The memory unit stores compressing parameter, which includes bits for improving the operation speed and reducing the processed signals. The second communication protocol unit has at least an operation function of processing a simplified communication protocol and connecting control protocol, so that the communication server could communicates with at least a user communication apparatus. The user communication apparatus comprises a processing module, an interface module and a button module. The processing module includes a register area and a third communication protocol unit. The third communication protocol unit has at least an operation function of processing a simplified communication protocol and simplified connecting control protocol, so that the user communication apparatus could communicates with a communication server. The register area stores a memory signal and a controlling signal temporarily for improving the working speed of the processing module. The interface module includes a signal receiving area and a signal sending area. The signal receiving area is for receiving a first audio/video signal from the processing module, transforming the first audio/video signal to a multimedia signal, and transmitting the multimedia signal to a user operating the user communication apparatus. The signal sending area is for receiving the multimedia signal from a user operating the user communication apparatus, transforming the multimedia signal to a second audio/video signal, and transmitting the second audio/video signal to the processing module. The button module is for transmitting a controlling signal for controlling the processing module transmitting the first audio/video signal or receiving the second audio/video signal.

The foregoing aspects and many of the attendant advantages of this invention will become more readily appreciated as the same becomes better understood by reference to the following detailed description, when taken in conjunction with the accompanying drawings, wherein:

### BRIEF DESCRIPTION OF THE DRAWINGS

FIG. 1 depicts a structure diagram showing a prior internet communication terminal system;

FIG. 2 depicts an operation diagram showing a prior internet communication terminal system;

FIG. 3 depicts a structure diagram showing a terminal system in accordance with the preferred embodiment of the present invention;

FIG. 4 depicts a structure diagram showing a user communication apparatus in accordance with the preferred embodiment of the present invention; and

FIG. 5 depicts an operation diagram showing a terminal system and a user communication apparatus thereof in accordance with the preferred embodiment of the present invention.

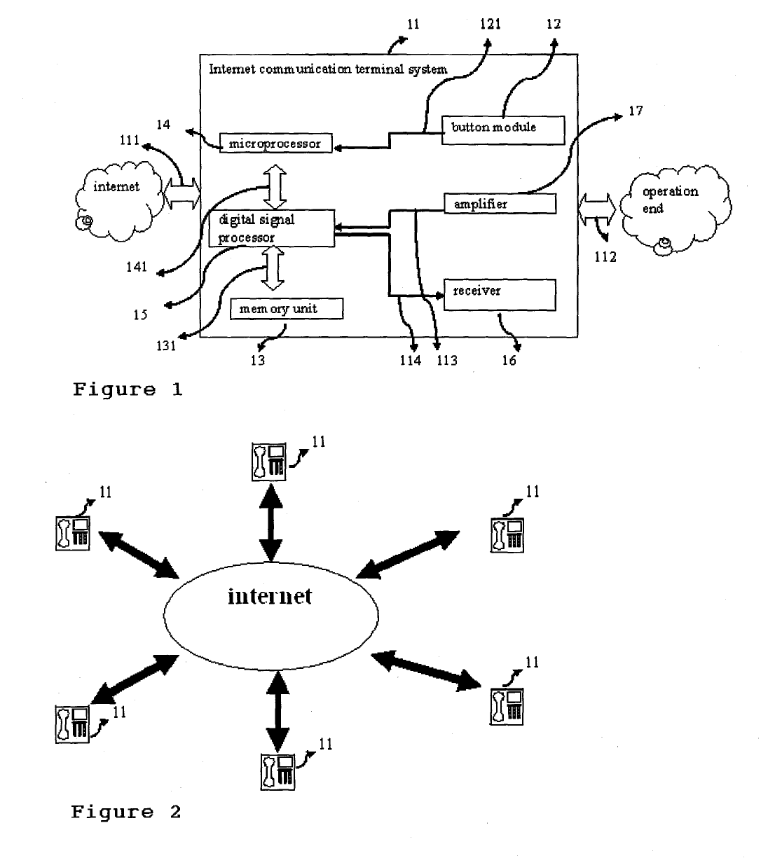

### DETAILED DESCRIPTION OF THE PREFERRED EMBODIMENT

A terminal system in accordance with the preferred embodiment of the present invention will be better understood by reference to the following detailed description, and in conjunction with the accompanying drawings, wherein the same devices use the same numbers.

In the present terminal system, each user communication apparatus communicates with another user communication apparatus through the communication server rather prior internet system. That is, the present terminal system performs an inter communication through a local network. The communication server communicates with another communication server through an internet. The function for processing communication protocol and for processing digital signal is performed on the communication server. The cost for web phone of the present invention is accordingly reduced very much.

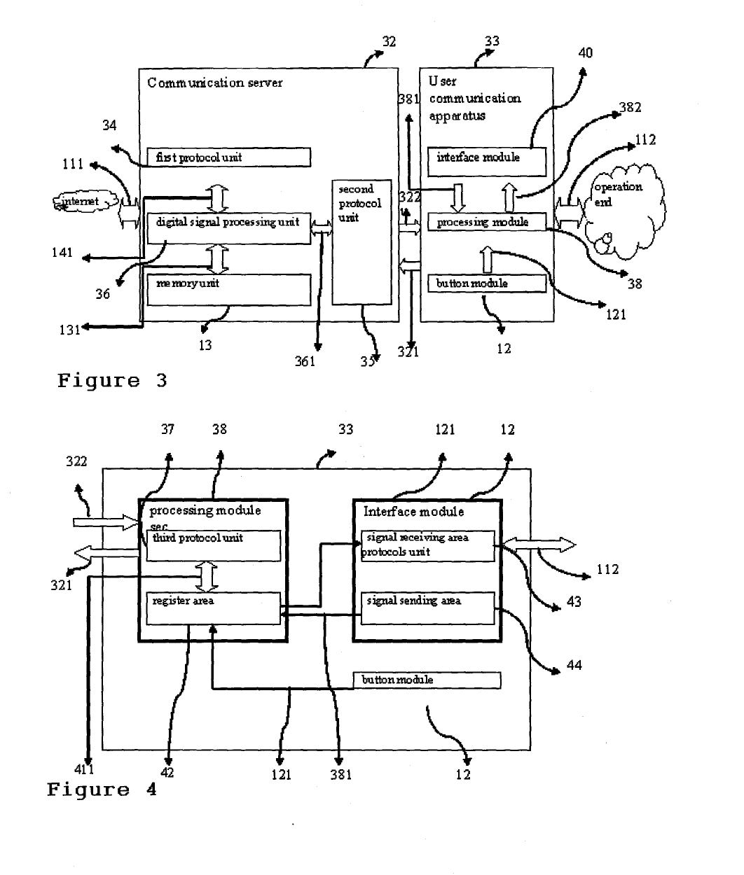

Reference is made to FIG. 3, which depicts a structure diagram showing a terminal system in accordance with the preferred embodiment of the present invention. The terminal system of the present invention comprises a communication server 32 and at least a user communication apparatus 33. The communication server 32 comprises a first communication protocol unit 34, a second communication protocol unit 35, a digital signal processing unit 36 and a memory unit 13. The user communication apparatus 33 comprises a processing module 38, an interface module 40 and a button module 12. The first communication protocol unit 34 receives a packet signal 111 from another terminal system. The packet signal 111 is operated and processed to a connecting signal 141, which is transmitted to the digital signal processing unit 36. The first communication protocol unit 34 could also receive the connecting signal 141, and the connecting signal 141 is operated and processed to a packet signal 111, which is then transmitted to another terminal system. The connecting signal 141 could be un-compressed, decoded, audio signal comforted, etc., to a working signal 361, which is then transmitted to the second communication protocol unit 35. The digital signal processing unit 36 could access a compressing parameter 131 from the memory unit 13. The compressing parameter 131 is preferred bits for improving the operation speed and reducing the processed signals. The digital signal processing unit 36 could also receive the working signal 361, perform the processes of un-compressing, decoding and echo eliminating, and transmit the connecting signal 141 to the first communication protocol unit 34. The second communication protocol unit 35 performs an operation of simplified communication protocol, receives the working signal 361, and transforms the working signal 361 to a second protocol signal 322, which is then transmitted to the user communication apparatus 33. The second communication protocol unit 35 could also receive a first protocol signal 321 and transform the first protocol signal 321 to the working signal 361, which is then transmitted to the digital signal processing unit 36. The user communication apparatus 33 comprises a processing module 38, an interface module 40 and a button module 12. The processing module 38 receives a first audio/video signal 381, the second protocol signal 322 and a controlling signal 121, and transmits a second audio/video signal 382 and the first protocol signal 321. The first protocol signal 321 and the second protocol signal 322 are signals transmitted between the user communication apparatus 33 and the communication server 32. The first audio/video signal 381 and the second audio/video signal 382 are signals transmitted between the processing module 38 and the interface module 40. The controlling signal 121 is a signal transmitted from the button module 12 to the processing module 38. A signal transmitted from the operation end is a multimedia signal 112, which is transformed to the first protocol signal 321 by the user communication apparatus 33. The first communication protocol unit 34 is embedded in the communication server 32 of the present terminal system. The first communication protocol unit 34 could transmit the packet signal 111 through at least an internet, and communicate with another terminal system. Therefore, an internet communication of the present invention is performed.

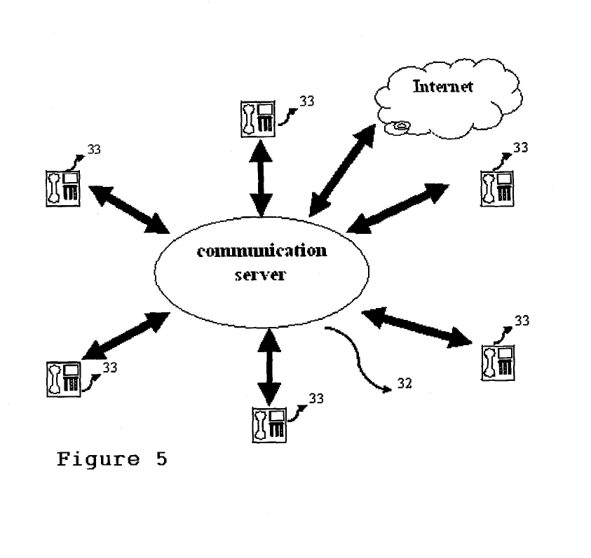

Reference is made to FIG. 4, which depicts a structure diagram showing a user communication apparatus in accordance with the preferred embodiment of the present invention. The user communication apparatus 33 comprises a processing module 38, an interface module 40 and a button module 12. The button module 12 transmits a controlling signal 121 to the processing module 38. The controlling signal 121 is used for controlling the processing module 38 to transmit a first protocol signal 321 and a second protocol signal 322. The interface module 40 comprises a signal receiving area 43 and a signal sending area 44. The signal receiving area 43 receives a second audio/video signal 382, and transforms the second audio/video signal 382 to a multimedia signal 112, which could be received by a user operating the user communication apparatus. The signal sending area 44 receives a multimedia signal 112 from a user operating the user communication apparatus, and transforms the multimedia signal 112 to a first audio/video signal 381, which is transmitted to the processing module 38. The processing module 38 comprises a third communication protocol unit 37 and a register area 42. The register area 42 transmits the second audio/video signal 382 and a memory signal 411, and receives the first audio/video signal 381, the memory signal 411 and the controlling signal 121. The register area 42 has the registering function for improving the working speed of the processing module 38. The third communication protocol unit 37 has an operation function of simplified communication protocol. The third communication protocol unit 37 is for connecting the user communication apparatus 33 and the communication server 32 (as shown in FIG. 3) by the first protocol signal 321 and the second protocol signal 322.

Reference is made to FIG. 5, which depicts an operation diagram showing a terminal system and a user communication apparatus thereof in accordance with the preferred embodiment of the present invention. A user communication apparatus 33 communicates with another user communication apparatus 33 through a communication server 32. Then the communication server 32 communicates with another communication server 32. Comparing with the prior terminal system, the terminal system of the present invention is an improved and function division terminal system. Therefore, the cost of the terminal system could be reduced very much. And the terminal system further comprises the features of globalization and mobility.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. A terminal system for an Internet communication, the terminal system comprising:
a communication server connecting to an Internet, the communication server comprising:
a first communication protocol unit having at least an operation function of processing a communication protocol for transmitting a packet signal to the Internet;
a second communication protocol unit having at least an operation function of processing a simplified communication protocol for receiving a first protocol signal and transmitting a second protocol signal; and
a digital signal processing unit in communication with the first communication protocol unit and the second communication protocol unit for processing signals transmitted between the first communication protocol unit and the second communication protocol unit; and
at least one user communication apparatus in communication with the communication server, the user communication apparatus comprising a third communication protocol unit having at least an operation function of processing a simplified communication protocol for transmitting the first protocol signal and receiving the second protocol signal.

2. The terminal system of claim 1, wherein the communication server comprises a memory unit for storing a compressing parameter.

3. The terminal system of claim 2, wherein the digital signal processing unit accesses the compressing parameter from the memory unit.

4. The terminal system of claim 1, wherein the packet signal comprises a coded digital signal.

5. The terminal system of claim 1, wherein the first protocol signal is an un-compressed audio/video signal.

6. The terminal system of claim 1, wherein the second protocol signal is an un-compressed audio/video signal.

7. The terminal system of claim 1, wherein the user communication apparatus is a user interface.

8. The terminal system of claim 7, wherein the user interface includes a telephone apparatus.

9. The terminal system of claim 1, wherein the user communication apparatus comprises a processing module for receiving a controlling signal and a first audio/video signal, and transmitting a second audio/video signal.

10. The terminal system of claim 9, wherein the user communication apparatus comprises a button module for transmitting the controlling signal.

11. The terminal system of claim 9, wherein the user communication apparatus comprises an interface module for receiving/transmitting a multimedia signal from/to the communication server, transmitting the first audio/video signal and receiving the second audio/video signal.

12. The terminal system of claim 11, wherein the interface module includes a signal receiving area for receiving the second audio/video signal and transmitting the multimedia signal to a user operating the user communication apparatus.

13. The terminal system of claim 11, wherein the interface module includes a signal sending area for sending the first audio/video signal and receiving the multimedia signal from a user operating the user communication apparatus.

14. The terminal system of claim 11, wherein the user communication apparatus comprises a casing for covering the interface module.

15. The terminal system of claim 11, wherein the user communication apparatus comprises a casing for covering the processing module and the interface module.

16. The terminal system of claim 9, wherein the processing module includes a register area for accessing at least a memory signal for improving the working speed of the processing module.
